(19) United States
(12) Patent Application Publication
(10) Pub. No.: US 2019/0204192 A1
(43) Pub. Date: Jul. 4, 2019

(54) FIBER OPTIC INTERROGATION SYSTEM FOR MULTIPLE DISTRIBUTED SENSING SYSTEMS

(71) Applicant: HALLIBURTON ENERGY SERVICES, INC., Houston, TX (US)

(72) Inventors: Mikko JAASKELAINEN, Katy, TX (US); Jason Edward THERRIEN, Cypress, TX (US); Seldon David BENJAMIN, Spring, TX (US)

(73) Assignee: Halliburton Energy Services, Inc., Houston, TX (US)

(21) Appl. No.: 16/302,541

(22) PCT Filed: Jul. 22, 2016
(86) PCT No.: PCT/US2016/043483

§ 371 Date: Nov. 16, 2018

(51) Int. Cl. G01N 3/08; G01N 29/04; G01N 29/24

(52) U.S. Cl. CPC G01N 3/08; G01N 29/04; G01N 2291/02881; G01N 2291/02827; G01N 29/2418

(57) ABSTRACT

Disclosed is a fiber optic interrogation system unit with one or more controllable laser sources that are electrically tuned to fit the laser source requirements for different sensing principles. Such an interrogation unit would employ a designed optical configuration at the distal end of the optical fiber to enable DAS, DTS and stimulated Brillouin DSS to operate on the same optical fiber. It would provide a single fiber optic interrogation system with integrated DTS, DAS and DSS systems that is cost effective and simple in design.

### BACKGROUND

The present embodiment relates in general to the field of fiber optic interrogation systems and, in particular, to a fiber optic interrogation system having optical sensors that provide multi-sensing functionality such as Distributed Temperature Sensing (DTS), Distributed Acoustic Sensing (DAS) and Distributed Strain Sensing (DSS), all utilizing one fiber optic interrogation system.

Fiber-optic sensing is a cost effective technology that offers major advantages over conventional measurement methods. In particular, fiber optic interrogation units are highly sensitive, allow for remote and distributed sensing, can be used in harsh environments, and are immune to electromagnetic interference. Such interrogation units are used for Distributed Temperature Sensing (DTS), Distributed Acoustic Sensing (DAS) and Distributed Strain Sensing (DSS) in many demanding applications. The interrogation unit works by coupling coherent laser energy pulses into optical fiber and accurately measuring the wavelengths of the light reflected back. However, each of the above mentioned sensing systems have unique requirements for their laser source.

DTS systems require laser sources with broad line widths and high total pulse power with low power spectral density to avoid non-linear effects. DAS systems require high power laser sources with very narrow line widths and long coherence lengths in order to function. DSS systems may require a probe laser which is swept across optical wavelengths to detect Brillouin shift along the optical fiber. Hence the laser source requirements for a DTS system are therefore significantly different from a DAS system, which is significantly different from a DSS system. However, there has been little or no incentive to combine the systems into a single interrogator given that there would have to be three different laser sources, which would increase the complexity of optical design, and entail a large mechanical footprint. Further, the optical fiber configuration requirement for measuring different sensing principles is also different for each one.

Different interrogator units are known in the art. Some existing interrogators provide down-hole monitoring with distributed optical density, temperature and/or strain sensing. However, this system fails to provide a controllable laser source that can provide light of different wavelength, and/or different laser line width, which is required for measuring different sensing principles. Some other existing fiber optic distributed temperature sensor systems provide a self-correction function while measuring temperature. But such systems fail to measure DTS, DAS and DSS utilizing the same sensor system. Another distributed fiber optic sensing system provides a sensor fiber comprising at least first and second waveguides used for separate sensing operations. However, in this system the sensor fiber is coupled to an interrogator system having two interrogator units and each interrogator unit includes separate light source coupled to the optical fiber. Attempts have been made to overcome these problems by developing an interrogation unit that provides the functionality of several different interrogation units like Distributed Temperature Sensing (DTS), Distributed Acoustic Sensing (DAS) and Distributed Strain Sensing (DSS) systems in the same unit.

There is thus a need for a fiber optic interrogation system having optical sensors that would provide multi-sensing functionality. Such an interrogation unit would allow sensing multiple functionalities like DTS, DAS and DSS. This interrogation unit would employ a controllable laser source that is electrically tuned to fit the laser source requirements for different sensing principles. Such an interrogation unit would employ a an optical configuration at the distal end of the optical fiber to enable DAS, DTS and stimulated Brillouin DSS to operate on the same optical fiber. It would provide a single fiber optic interrogation system with integrated DTS, DAS and DSS systems that is cost effective and simple in design. The present embodiment overcomes the existing shortcomings in this area by accomplishing these objectives.

### BRIEF DESCRIPTION OF THE DRAWINGS

Elements in the figures have not necessarily been drawn to scale in order to enhance their clarity and improve understanding of these various elements and embodiments of the application. Furthermore, elements that are known to be common and well understood to those in the industry are not depicted in order to provide a clear view of the various embodiments of the application, thus the drawings are generalized in form in the interest of clarity and conciseness.

FIG. 1 illustrates a block diagram of a fiber optic interrogation system utilized for sensing a plurality of sensing principles in accordance with an embodiment of the present application;

FIG. 2 illustrates a block diagram of at least one controllable laser source unit employed in the fiber optic interrogation system of the present application;

FIG. 3 illustrates a block diagram of the fiber optic interrogation system in accordance with another embodiment of the present application;

FIG. 4 illustrates a back-scattered optical spectrum from an optical fiber of the fiber optic interrogation system of the present application; and

FIG. 5 is a flow chart of a method for sensing the plurality of sensing principles utilizing the fiber optic interrogation system of the present application.

### DETAILED DESCRIPTION

In the following detailed description, reference is made to accompanying drawings that illustrate embodiments of the present disclosure. These embodiments are described in sufficient detail to enable a person of ordinary skill in the art to practice the disclosure without undue experimentation. It should be understood, however, that the embodiments and examples described herein are given by way of illustration only, and not by way of limitation. Various substitutions, modifications, additions, and rearrangements may be made without departing from the spirit of the present disclosure. Therefore, the description that follows is not to be taken in a limited sense, and the scope of the present disclosure will be defined only by the final claims.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

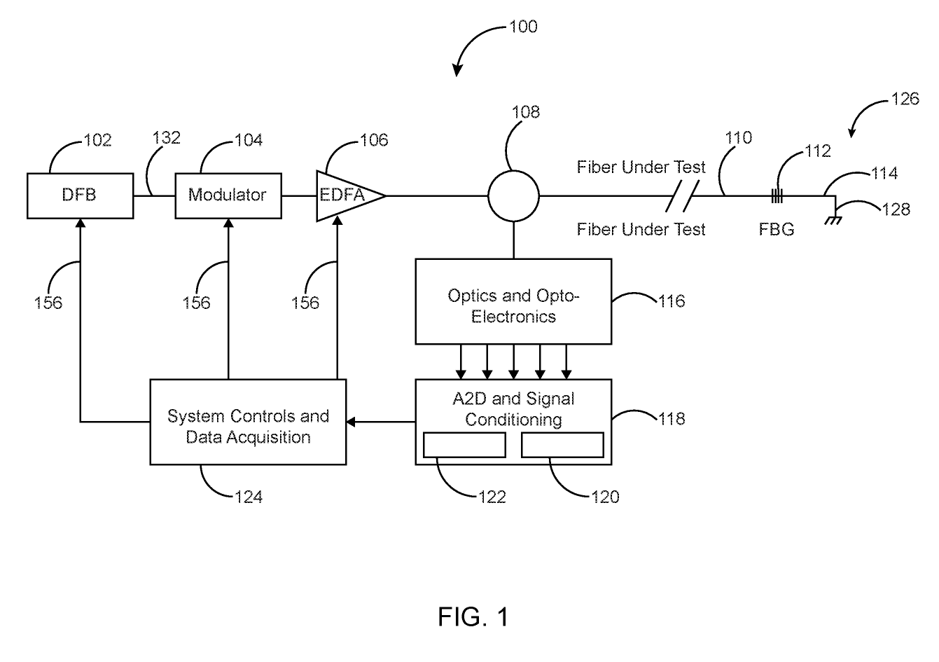

Referring to FIG. 1, a block diagram of a fiber optic interrogation system 100 utilized for measuring a plurality of sensing principles (not shown) in accordance with an embodiment of the present application is illustrated. The present application provides a multi-sensing single fiber optic interrogation system 100 that provides the functionality of several different interrogation units, for example, Distributed Temperature Sensing (DTS), Distributed Acoustic Sensing (DAS) and Distributed Strain Sensing (DSS) in the same system.

The fiber optic interrogation system 100 of the present application comprises at least one controllable laser source unit 102, a modulator 104 attached to the controllable laser source unit 102, an amplifier 106 for amplifying the modulated signal from the modulator 104, a circulator 108, an optic and optoelectronics unit 116, an analog to digital and signal-conditioning unit 118, a system control and data acquisition unit 124 and an optical fiber 110 having a designed down-hole configuration 126. This disclosure discusses in detail the fiber optic interrogation system 100 and a method for sensing the plurality of sensing principles (not shown) utilizing the same system. Each of the plurality of sensing principles can be selected from a group consisting of: Distributed Temperature Sensing (DTS), Distributed Acoustic Sensing (DAS) and Distributed Strain Sensing (DSS).

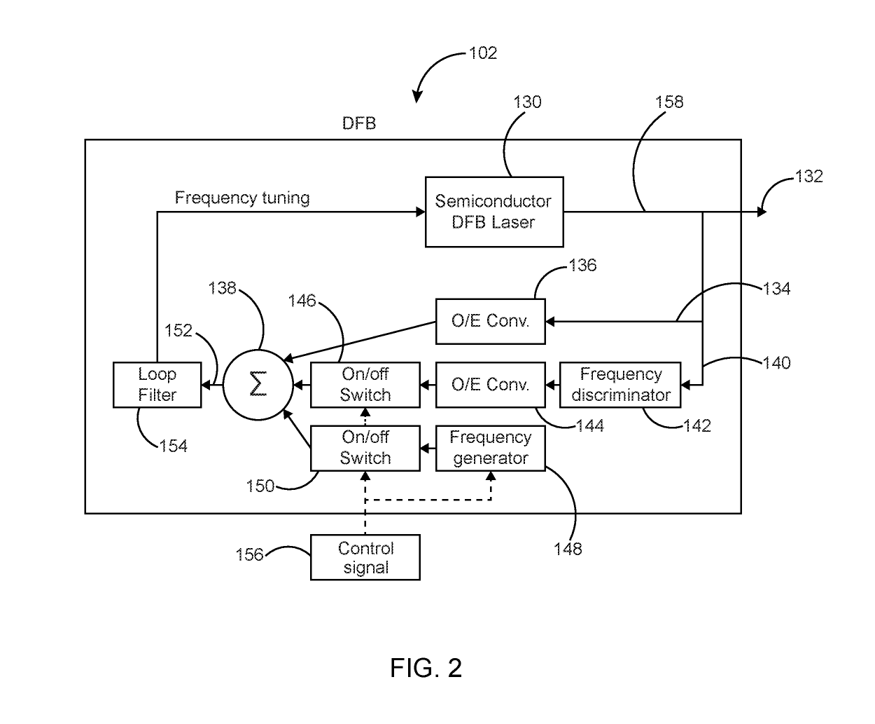

Turning now to FIG. 2 the at least one controllable laser source unit 102 is electrically tuned to fit the laser source requirements of each of the plurality of sensing principles. The controllable laser source unit 102 provides an input laser beam 132 into the optical fiber 110 depending on the requirements of the laser beam characteristics required for each of the plurality of sensing principles.

For example, DTS systems require laser sources with broad line widths and high total pulse power with low power spectral density to avoid non-linear effects. For DTS systems, narrow line width laser sources will experience non-linear effects and the amount of optical power that can be transmitted into the optical fiber is greatly reduced with narrow line width lasers. For sensing DAS systems, high power laser sources with very narrow line width and long coherence length are required. In DSS systems, a probe laser, which is swept across optical wavelengths to detect Brillouin shifts along the optical fiber is required. Hence the laser source requirements for a DTS system are therefore significantly different from a DAS system, which is significantly different from a DSS system.

The at least one controllable laser source unit 102 of the present application is capable of providing the laser source requirements that enable DAS, DTS and stimulated Brillouin DSS on the same optical fiber 110. The at least one controllable laser source unit 102 provides the input laser beam 132 to the modulator 104 attached to it depending on the requirements of at least one sensing principle. The modulator 104 is adaptable to modulate the amplitude and/or phase of the signal passing therethrough. Conventional optical modulator uses an electrical signal to modulate some property of the optical signal, like the phase or the amplitude. Similarly, the laser source may also be modulated. As modulated signals can be easily transferred through the optical fiber or processed by other optical or optoelectronic devices optical modulator are commonly used for such applications. The modulator 104 of the present application provides amplitude modulation for DAS and DTS systems. For DSS system, the modulator 104 provides amplitude and/or phase modulation. The amplifier 106 is attached to the modulator 104 and configured to amplify the signal from the modulator 104. The amplifier 106 can preferably be an Erbium Doped Fiber Amplifier (EDFA). Erbium-doped fiber amplifiers are the most important fiber amplifiers in the context of long-range optical fiber communications. In an EDFA, the core of a silica fiber is doped with trivalent erbium ions and can be efficiently pumped with a laser at a wavelength of 980 nm or 1,480 nm, and exhibits gain in the 1,550 nm regions. EDFA provide in-line amplification of optical signals by effecting stimulated emission of photons by erbium ions implanted in the core of the optical fiber. The amplified signal is then passed to the circulator 108 connected with amplifier 106. The circulator 108 is a special fiber-optic component that can be used to separate optical signals that travel in opposite directions in the optical fiber 110. Circulator 108 is used to achieve bi-directional transmission over the single optical fiber 110. The amplified signal from the circulator 108 is then injected into the optical fiber 110 which is configured to sense the at least one sensing principle.

The optical fiber 110 includes a designed configuration 126 at a distal end 128, which enables sensing of the plurality of sensing principles (not shown). The configuration 126 includes a Fiber Bragg Grating (FBG) section 112 followed by a low reflectance termination section 114. Optical fiber based distributed sensing is based on monitoring changes to the intrinsic properties of the light within the fiber when it is exposed to environmental changes, such as temperature or pressure. The distributed sensing methods are based on light scattering and optical time-domain reflectometer (OTDR) technology. The backscattered and reflected signals from the optical fiber 110 used in distributed sensing applications are Rayleigh, Brillouin, and Raman scattering. The FBG section 112 is designed to reflect the wavelength of the DSS system and allows the wavelengths of the DAS and DTS systems to pass through to the low reflectance termination section 114. The configuration 126 at the distal end 128 of the optical fiber 110 allows measurement of DAS, DTS and DSS systems with different characteristics by the same fiber optic interrogation system 100. The optic and optoelectronics unit 116 is attached to the circulator 108 and is configured to separate out unwanted optical frequencies and associated signals from the backscattered and reflected signals from the optical fiber 110. The optic and optoelectronics unit 116 preferably, includes devices that responds to optical power, emits or modifies optical radiation or utilizes optical radiation for its internal operation or any device that functions as an electrical-to-optical or optical-to-electrical transducer. The analog to digital and signal-conditioning unit 118 is attached to the optic and optoelectronics unit 116. The analog to digital and signal-conditioning unit 118 includes an analog to digital converter 122 and a signal-conditioning unit 120. The signal-conditioning unit 120 manipulates the signal from the optic and optoelectronics unit 116 and provides it to the analog to digital converter 122. The system control and data acquisition unit 124 is attached to the analog to digital and signal-conditioning unit 118 which is configured to provide a control signal 156 that controls the drive current of the at least one controllable laser source unit 102. Data acquisition is the process of sampling signals that measure real world physical conditions and converting the resulting samples into digital numeric values that can be manipulated by a computer. Data acquisition systems, typically convert analog waveforms into digital values for processing. The system control and data acquisition unit 124 is also configured to provide a control signal 156 to control the functioning of modulator 104 and amplifier 106. The value of the control signals 156 reaching laser source 102, modulator 104, and amplifier 106 may of course vary for each of those units. The data for further processing and measurement of the at least one sensing principle can be retrieved from the system control and data acquisition unit 124. Thus the multi-sensing fiber optic interrogation system 100 of the present application provides the controllable laser source unit 102 that is electrically tuned to fit the laser source requirements for the plurality of sensing principles and the configuration 126 at the distal end 128 of the optical fiber 110 enables sensing of the plurality of sensing principles (not shown) on the same fiber 110.

In operation, the at least one controllable laser source unit 102 provides the required input laser beam 132 to the modulator 104 connected therewith. In case of DAS and DTS systems, the modulator 104 provides amplitude modulation and in case of DSS systems the modulator 104 provides amplitude and phase modulation. The modulated signal is then fed to the amplifier 106 where the signal gets amplified. The amplifier 106 can be, for example, an erbium doped fiber amplifier (EDFA) that receives light signal from the controllable laser source unit 102 preferably having a wavelength around 1.5 μm and amplify the signal to around 1.5 μm wavelength region with desired amplitude. The amplified signal is then passed through the circulator 108 and fed to the optical fiber 110 having the optical down-hole configuration 126 with the Fiber Bragg Grating (FBG) section 112 followed by the very low reflectance termination section 114 at the distal end 128. The fiber Bragg grating section 112 is a type of distributed Bragg reflector constructed in a short segment of the optical fiber 110 that reflects particular wavelengths of light and transmits all others. In the present application, the FBG section 112 is designed to reflect the wavelength of the DSS system while passing the other wavelengths through to the low reflectance termination section 114. In DTS and DAS systems, it is desirable to minimize (or eliminate) reflectance because high amplitude signals returning from the distal end 128 of the optical fiber 110 can lead to undesirable signal conflict and a low signal to noise ratio. So low reflectance termination is preferred which can be achieved by making use of a coreless fiber at the distal end 128.

As the input laser beam 132 travels along the length of the optical fiber 110, a small amount of the signal is backscattered by Rayleigh, Brillouin, and/or Raman scattering effects. In the present application, as the signal travels down-hole the optical fiber 110, Brillouin DSS signals encounter the FBG section 112 and are reflected back down the optical fiber 110. The Brillouin system may e.g. be used in a pump-probe configuration where a continuous wave probe pulse is reflected off the FBG to generate a counter propagating continuous wave probe, and the local Brillouin shift can be obtained by sweeping the frequency offset between a pump pulse and a counter-propagating continuous-wave probe. The signals from the DTS and DAS which are at different frequencies pass through the FBG section 112 and are only very weakly reflected back into the optical fiber 110 by the low reflectance termination section 114. The backscattered light and the reflected light that return back down the optical fiber 110, then pass through the circulator 108 and are directed to the optic and optoelectronics unit 116. The optic and optoelectronics unit 116 separates out unwanted optical frequencies and associated signals and provides the required optical signal for each of the plurality of sensing principles (not shown). The analog to digital and signal-conditioning unit 118 along with the system control and data acquisition unit 124 separate out the relevant optical frequencies for each of the plurality of sensing principles for further processing. The control signal 156 from the analog to digital and signal-conditioning unit 118 and the system control and data acquisition unit 124 controls the drive current of the controllable laser source unit 102, the modulator 104 and the amplifier 106 and gather the data to measure key measurements such as distributed acoustics, temperatures, and strain.

FIG. 2 illustrates a block diagram of the at least one controllable laser source unit 102 employed in the fiber optic interrogation system 100 of the present application. The at least one controllable laser source unit 102 is adaptable to provide the input laser beam 132 to the optical fiber 110 depending on the requirements of at least one sensing principle. The controllable laser source unit 102 comprises a laser source 130 configured to provide a laser beam 158, a first feedback loop 134 having a first optical to electrical (O/E) converter 136 connected to a summation unit 138, a second feedback loop 140 having a frequency discriminator 142 attached to a second optical to electrical (O/E) converter 144, a frequency discriminator 142, a frequency generator 148 and a loop filter 154. These feedback loops together with the frequency discriminator, frequency generator, and loop filter combine to set a base drive current set point (not shown) for the semiconductor DFB laser 130. The feedback loops 134, 140 operate to subtract the high frequency noise that normally broadens the line width. The System Controls and Data Acquisition unit 124 of FIG. 1 supplies the control signal 156 that provides the drive current set point to the semiconductor DFB laser 130 of FIG. 2. Different set points are supplied to the laser source depending on the characteristics required for each of the plurality of sensing principles.

The laser source 130 is configured to supply a coherent laser beam 158 to the fiber optic interrogation system 100. The laser source 130 can preferably be a semiconductor distributed feedback laser. The distributed feedback (DFB) laser is a type of laser diode, quantum cascade laser or optical fiber laser where the active region of the device is periodically structured as a diffraction grating. In the case of a semiconductor diode laser the diffraction grating includes a grating layer having a periodic refractive index that is different from the refractive index of the adjacent layers. The DFB laser operates in a single mode emitting laser light of a stable single wavelength and thus is widely used as the light source in optical communication systems. The first feedback loop 134 from the laser source 130 having the first optical to electrical (O/E) converter 136 is connected to the summation unit 138. The summation unit 138 is configured to provide a resultant output 152 of the signals reaching therein. The second feedback loop 140 from the laser source 130 having the frequency discriminator 142 attached to the second optical to electrical (O/E) converter 144 is connected to the summation unit 138 by means of a first switch 146. The frequency discriminator 142 is adaptable to convert frequency changes in the signals reaching therethrough into amplitude changes. The frequency generator 148 is configured to add a high frequency AC component to the signals reaching the summation unit 138 to alter, i.e. broaden the line width of the input laser beam 132 or narrow the line width of the input laser beam 132. A second switch 150 connects the frequency generator 148 with the summation unit 138. The summation unit 138 receives the signals from the first feedback loop 134, the second feedback loop 140 and the frequency generator 148 and provides the resultant output signal 152. The loop filter 154 is connected to the output of the summation unit 138 that provides the required drive current to the laser source 130. The control signals 156 from the system control and data acquisition unit 124 (see FIG. 1) controls the functioning of the frequency generator 148, the first switch 146 and the second switch 150.

Employing filtering and feedback loops can reduce the laser source line width and applying the high frequency AC signal as the drive current for the laser source 130 can broaden the line width. In the present application, the first feedback loop 134 and the second feedback loop 140 are designed to tap off some light to narrow the line width and add a correction signal to the drive current. The first feedback loop 134 and the second feedback loop 140 narrows the line width, increase the coherence length of the laser source 130 and make it suitable for DAS systems based on coherent Rayleigh scattering. The frequency generator 148 is employed to add high frequency AC component on the laser source drive current to broaden the line width and thereby decrease the power spectral density to make it suitable for Raman based DTS systems. The frequency generator 148 can also be used to modulate the laser drive current to make a probe signal and/or make a high power pump pulse used in stimulated Brillouin DSS system.

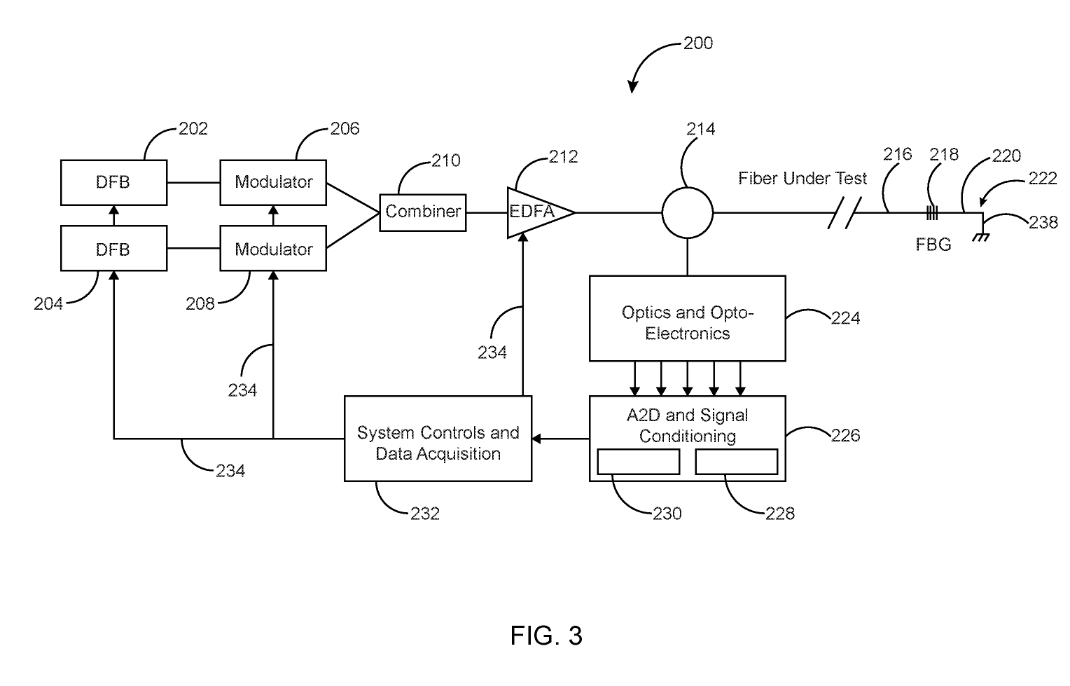

FIG. 3 illustrates a block diagram of the fiber optic interrogation system 200 in accordance with another embodiment. This embodiment comprises a pair of controllable laser source units 202, 204, a first modulator 206, a second modulator 208, a combiner 210, an amplifier 212 connected to a circulator 214, an optical fiber 216 with a configuration 222 having a Fiber Bragg Grating (FBG) section 218 followed by a low reflectance termination section 220, a optic and optoelectronics unit 224, an analog to digital and signal-conditioning unit 226 and a system control and data acquisition unit 232. In this embodiment, the pair of controllable laser source units 202, 204 are used for a dual laser Raman based DTS system when tuned for broad line widths, and the same pair of controllable laser source units 202, 204 can be used in a frequency locked mode for dual wavelength coherent Rayleigh DAS system, and the same pair of controllable laser source units 202, 204 can be used in a pump/probe combination where one of the controllable laser source unit 202 is used for providing a probe signal and the other controllable laser source unit 204 for providing a high power pump signal to allow measurement of Brillouin shift in the DSS system. One of the pair of controllable laser source units 202 is attached to the first modulator 206 and the other controllable laser source unit 204 is connected to the second modulator 208. The output signal from the first modulator 206 and the second modulator 208 is combined by the combiner 210 and provided to the amplifier 212. The amplified signal is passed to the optical fiber 216 through the circulator 214. The Brillouin DSS signals encounter the FBG section 218 and are reflected back down the optical fiber 216. The signals from the DTS and DAS which are at different frequencies pass through the FBG section 218 and are only very weakly reflected back into the optical fiber 216 by the low reflectance termination section 220. These backscattered and reflected signals from the optical fiber 216 are captured from the circulator 214 by the optic and optoelectronics unit 224. The backscattered and reflected signals are separated in the optic and optoelectronics unit 224 and supplied to the analog to digital and signal-conditioning unit 226. The analog to digital and signal-conditioning unit 226 includes a signal-conditioning unit 228 and an analog to digital converter 230. The signal-conditioning unit 228 performs the conditioning of the signal and provides it to the analog to digital converter 230 that converts the analog signal into digital signal. The digital signal thus obtained is provided to the system control and data acquisition unit 232 that generates a control signal 234 to control the drive current of each of the pair of controllable laser source units 202, 204, the first modulator 206, the second modulator 208, and the amplifier 212. The system control and data acquisition unit 232 generates data that can be used for further processing and to measure key measurements such as distributed acoustics, temperatures, and strain.

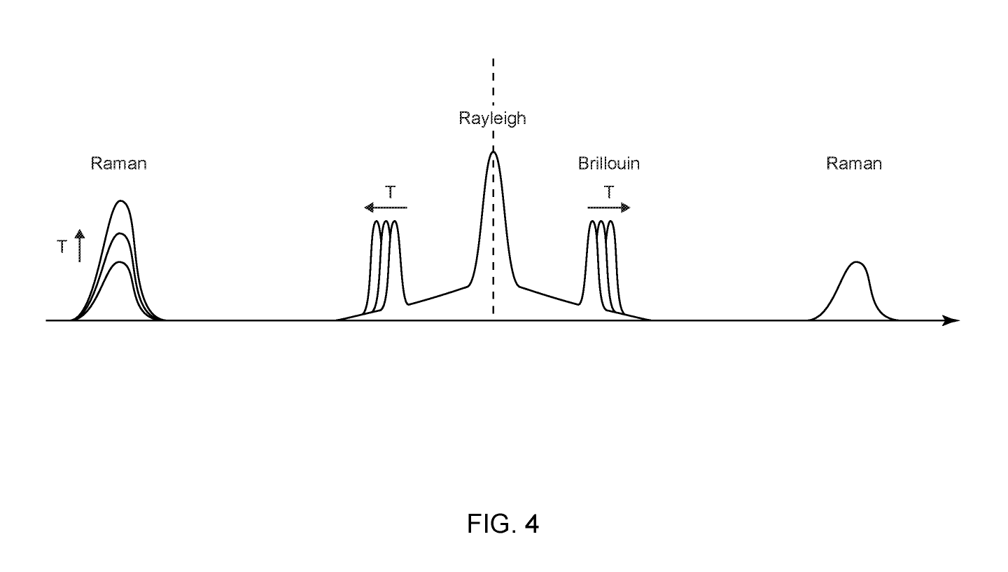

FIG. 4 illustrates a backscattered optical spectrum from the optical fiber 110 of the fiber optic interrogation system 100. The backscattered signals include Raman, Brillouin and Rayleigh bands as illustrated in FIG. 4. The controllable laser source unit 102 provides Raman bands that can be used for measuring DTS system and a frequency locked mode coherent Rayleigh band for measuring DAS system, in a pump/probe combination to produce Brillouin shift to detect and measure DSS system.

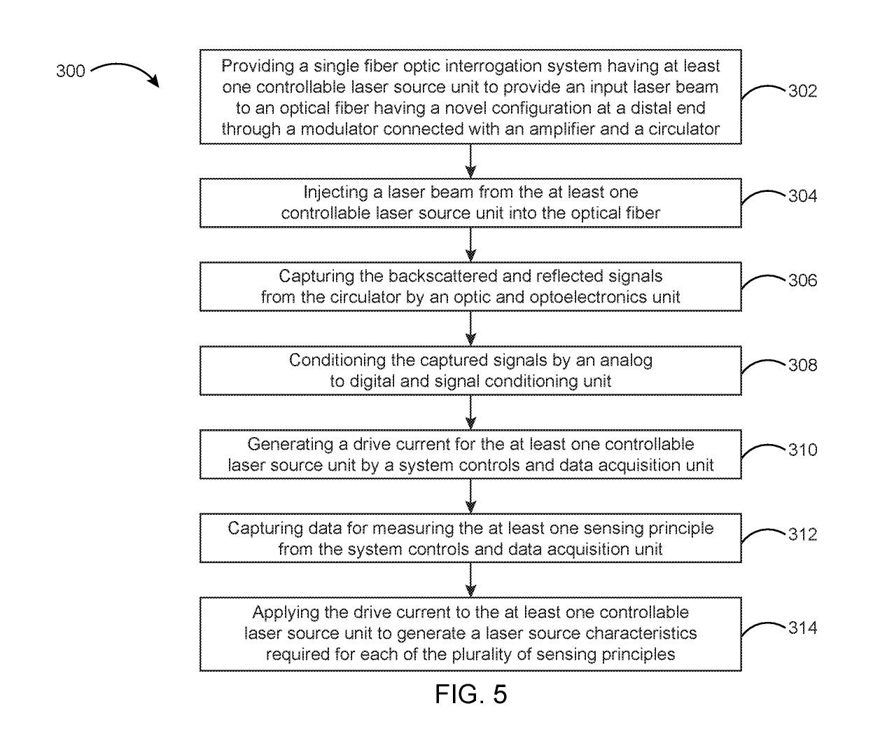

FIG. 5 is a flow chart of a method for sensing the plurality of sensing principles utilizing the fiber optic interrogation system 100. The method 300 for sensing the plurality of sensing principles utilizing the single fiber optic interrogation system 100 comprises the steps of providing the fiber optic interrogation system having at least one controllable laser source unit adaptable to provide an input laser beam for sensing at least one sensing principle through a modulator connected with an amplifier and a circulator, to an optical fiber having a designed configuration at a distal end, said configuration includes a fiber Bragg grating section followed by a low reflectance termination section as indicated in block 302. Then injecting an input laser beam from the at least one controllable laser source unit into the optical fiber as indicated in block 304. The injected laser beam travels through the optical fiber having the configuration at the distal end. The configuration includes a Fiber Bragg Grating (FBG) section followed by a low reflectance termination section. As the signal travels down-hole the optical fiber, Brillouin DSS signals encounter the FBG section and are reflected back down the optical fiber. The signals from the DTS and DAS, which are at different frequencies pass through the FBG section and are only very weakly reflected back into the optical fiber by the low reflectance termination section. The backscattered and reflected signals from the circulator are captured by an optic and optoelectronics unit as indicated in block 306. As indicated in block 308, the captured analog signals are conditioned and converted into digital signal by an analog to digital and signal-conditioning unit. A drive current for the at least one controllable laser source unit is generated by a system controls and data acquisition unit as indicated in block 310. Then capturing data from the system controls and data acquisition unit for measuring the at least one sensing principle as indicated in block 312 and applying the drive current to the at least one controllable laser source unit to generate a laser source characteristics required for each of the plurality of sensing principles as indicated in block 314. The method is employed for sensing at least one sensing principle selected from a group consisting of: Distributed Temperature Sensing (DTS), Distributed Acoustic Sensing (DAS) and Distributed Strain Sensing (DSS).

### Value Added

This application provides a single fiber optic interrogation system 100 with integrated DTS, DAS and DSS systems, which is cost effective and simple in design. The present application provides electrically controlled DFB laser source unit 102 to actively change laser source characteristics for different sensing applications and the optical configuration 126 at the distal end 128 of the optical fiber 110 enable DTS, DAS and stimulated Brillouin DSS on the same fiber.

Although certain embodiments and their advantages have been described herein in detail, it should be understood that various changes, substitutions and alterations could be made without departing from the coverage as defined by the appended claims. Moreover, the potential applications of the disclosed techniques is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized. Accordingly, the appended claims are intended to include within their scope such processes, machines, manufactures, means, methods or steps.

1. A fiber optic interrogation system utilized for sensing multiple sensing principles, comprising:
a. at least one controllable laser source unit adaptable to provide an input laser beam for sensing at least one sensing principle, the at least one controllable laser source comprising:
i. a laser source configured to provide a laser beam;
ii. a first feedback loop from the laser source having a first optical to electrical (O/E) converter connected to a summation unit, the summation unit configured to provide a resultant output of the signals reaching therein;
iii. a second feedback loop from the laser source having a frequency discriminator attached to a second optical to electrical (O/E) converter and connected to the summation unit by means of a first switch, the frequency discriminator adaptable to convert frequency changes in the signals reaching therein into amplitude changes;
iv. a frequency generator connected to the summation unit by means of a second switch, the frequency generator configured to add a high frequency AC component to the signals reaching the summation unit to broaden the line width; and
b. a loop filter configured to provide a required drive current to the laser source connected to an output of the summation unit;
c. a modulator configured to modulate the amplitude and phase of the signal passing therethrough, the modulator attached to the output of the at least one controllable laser source unit;
d. an amplifier attached to a circulator configured to amplify the signal therein and provide the amplified signal to the circulator, the amplifier connected to the output of the modulator;
e. an optical fiber having a designed configuration at a distal end attached to the output of the circulator, the optical fiber configured to sense the at least one sensing principle, the designed configuration includes a fiber Bragg grating (FBG) section followed by a low reflectance termination section;
f. an optic and optoelectronics unit attached to the circulator and configured to separate out unwanted optical frequencies and associated signals from the backscattered and reflected signals from the optical fiber;
g. an analog to digital and signal-conditioning unit attached to the output of the optic and optoelectronics unit, the analog to digital and signal-conditioning unit includes an analog to digital converter and a signal-conditioning unit, the signal-conditioning unit manipulates the signal from the optic and optoelectronics unit and provide it to the analog to digital converter; and
h. a system control and data acquisition unit attached to the analog to digital and signal-conditioning unit, the system control and data acquisition unit configured to control the drive current on the laser source and provide data to measure the at least one sensing principle;
i. whereby the designed optical fiber configuration at the distal end of the optical fiber enables sensing of a plurality of sensing principles on the same optical fiber utilizing the at least one controllable laser source unit electrically tuned to fit the laser source requirements for each of the plurality of sensing principles.

2. The fiber optic interrogation system of claim 1 wherein the at least one sensing principle can be selected from a group of one or more of: Distributed Temperature Sensing (DTS), Distributed Acoustic Sensing (DAS) and Distributed Strain Sensing (DSS).

3. The fiber optic interrogation system of claim 1 wherein the laser source is a semiconductor distributed feedback laser.

4. The fiber optic interrogation system of claim 1 wherein the summation unit generates the resultant output signal from the signals received from the first feedback loop, the second feedback loop and the frequency generator.

5. The fiber optic interrogation system of claim 2 wherein the first feedback loop and the second feedback loop narrows the line width, increases the coherence length of the laser source and makes it suitable for DAS systems based on coherent Rayleigh scattering.

6. The fiber optic interrogation system of claim 2 wherein the frequency generator broadens the line width and thereby decreases the power spectral density and makes it suitable for Raman based DTS systems.

7. The fiber optic interrogation system of claim 2 wherein the frequency generator modulates the laser source drive current to make a probe signal and/or make a high power pump pulse used in stimulated Brillouin DSS system.

8. The fiber optic interrogation system of claim 1 wherein the amplifier can be an erbium doped fiber amplifier (EDFA).

9. The fiber optic interrogation system of claim 2 wherein the modulator provides amplitude modulation for DAS and DTS systems.

10. The fiber optic interrogation system of claim 2 wherein the modulator provides amplitude and phase modulation for DSS systems.

11. The fiber optic interrogation system of claim 2 wherein the FBG section is designed to reflect the wavelength of the DSS system and allows the wavelengths of the DAS and DTS systems to pass through to the low reflectance termination section.

12. The fiber optic interrogation system of claim 1 wherein the system control and data acquisition unit controls the drive current on the at least one controllable laser source unit, the modulator and the amplifier.

13. A method for sensing a plurality of sensing principles, the method comprising:
a. providing a single fiber optic interrogation system having at least one controllable laser source unit adaptable to provide an input laser beam for sensing at least one sensing principle through a modulator connected with an amplifier and a circulator, to an optical fiber having a designed configuration at a distal end, the designed configuration includes a Fiber Bragg Grating (FBG) section followed by a low reflectance termination section;
b. injecting a laser beam from the at least one controllable laser source unit into the optical fiber;
c. capturing the backscattered and reflected signals from the circulator by an optic and optoelectronics unit;
d. conditioning the captured signals by an analog to digital and signal-conditioning unit;
e. generating a drive current for the at least one controllable laser source unit by a system control and data acquisition unit;
f. capturing data for measuring the at least one sensing principle from the system control and data acquisition unit; and
g. applying the drive current to the at least one controllable laser source unit to generate a laser source characteristics required for each of the plurality of sensing principles.

14. The method of claim 13 wherein the at least one sensing principle can be selected from a group of one or more of: Distributed Temperature Sensing (DTS), Distributed Acoustic Sensing (DAS) and Distributed Strain Sensing (DSS).

15. The method of claim 14 wherein the FBG section is designed to reflect the wavelength of the DSS system and allows the wavelengths of the DAS and DTS systems to pass through to the low reflectance termination section.

16. The method of claim 14 wherein applying the drive current to the at least one controllable laser source unit increases the coherence length of the laser source and makes it suitable for DAS systems based on coherent Rayleigh scattering.

17. The method of claim 14 wherein applying the drive current to the at least one controllable laser source unit broadens the line width and thereby decreases the power spectral density and makes it suitable for Raman based DTS systems.

18. The method of claim 14 wherein applying the drive current to the at least one controllable laser source unit make a probe signal and/or make a high power pump pulse used in stimulated Brillouin DSS system.

19. The method of claim 14 wherein the modulator provides amplitude modulation for DAS and DTS systems.

20. The method of claim 14 wherein the modulator provides amplitude and phase modulation for DSS systems.
